(19) United States
(12) Patent Application Publication
(10) Pub. No.: US 2024/0289644 A1
(43) Pub. Date: Aug. 29, 2024

(54) Predictive Maintenance with Pretrained Feature Extraction for Manufacturing

(71) Applicant: Robert Bosch GmbH, Stuttgart (DE)

(72) Inventors: Filipe Condessa, Pittsburgh, PA (US); Devin Willmott, Pittsburgh, PA (US); Ivan Batalov, Pittsburgh, PA (US); Joao Semedo, Pittsburgh, PA (US); Wan-Yi Lin, Wexford, PA (US); Bahare Aazari, San Jose, CA (US)

(21) Appl. No.: 18/175,959

(22) Filed: Feb. 28, 2023

(51) Int. Cl. G06N 5/022

(52) U.S. Cl. CPC G06N 5/022

(57) ABSTRACT

A computer-implemented system and method includes establishing a station sequence that a given part traverses. Each station includes a machine that performs at least one operation with respect to the given part. Measurement data, which relates to attributes of a plurality of parts that traversed the plurality of machines, is received. The measurement data is obtained by sensors and corresponds to a current process period. A first machine learning model is pretrained to generate (i) latent representations based on the measurement data and (ii) machine states based on the latent representations. Machine observation data, which relates to the current process period, is received. Aggregated data is generated based on the measurement data and the machine observation data. A second machine learning model generates a maintenance prediction based on the aggregated data. The maintenance prediction corresponds to a next process period.

### TECHNICAL FIELD

This disclosure relates generally to predictive maintenance, and more particularly to machine learning systems that generate maintenance predictions to determine maintenance actions for industrial machines and/or manufacturing processes.

### BACKGROUND

An industrial manufacturing process may include a number of workstations with industrial machines, which are employed in a particular order to produce a particular product. For example, such industrial manufacturing processes are typically used in assembly plants. Unfortunately, there may be instances in which one or more industrial machines may fail to perform at satisfactory levels or may fail completely. Such machine failures may result in low grade products, incomplete products, and/or disruptions in the industrial manufacturing process, as well as major losses in resources, time, etc.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a computer-implemented method for predictive maintenance includes establishing a station sequence that includes a plurality of stations that a given part traverses. Each station includes at least one machine that performs at least one operation with respect to the given part. The method includes receiving measurement data relating to attributes of a plurality of parts. The measurement data is obtained by one or more sensors at each station of the plurality of stations. The measurement data corresponds to a current process period. The method includes generating, via a first machine learning model, latent representations, by encoding the measurement data into a latent space. The method includes generating, via the first machine learning model, at least machine states of the plurality of machines based on the latent representations. The method includes receiving machine observation data relating to the current process period. The machine observation data indicates conditions of the plurality of machines at the plurality of stations. The method includes generating aggregated data that is based on the measurement data and the machine observation data. The method includes generating, via a second machine learning model, a maintenance prediction based on the aggregated data, the maintenance prediction corresponding to a next process period.

According to at least one aspect, a system includes a processor and a memory. The memory is in data communication with the processor. The memory has computer readable data including instructions stored thereon that, when executed by the processor, cause the processor to perform a method for predictive maintenance. The method includes establishing a station sequence that includes a plurality of stations that a given part traverses. Each station includes at least one machine that performs at least one operation with respect to the given part. The method includes receiving measurement data relating to attributes of a plurality of parts. The measurement data is obtained by one or more sensors at each station of the plurality of stations. The measurement data corresponds to a current process period. The method includes generating, via a first machine learning model, latent representations, by encoding the measurement data into a latent space. The method includes generating, via the first machine learning model, at least machine states of the plurality of machines based on the latent representations. The method includes receiving machine observation data relating to the current process period. The machine observation data indicates conditions of the plurality of machines at the plurality of stations. The method includes generating aggregated data that is based on the measurement data and the machine observation data. The method includes generating, via a second machine learning model, a maintenance prediction based on the aggregated data, the maintenance prediction corresponding to a next process period.

According to at least one aspect, a non-transitory computer readable medium having computer readable data including instructions stored thereon that, when executed by a processor, cause the processor to perform a method for predictive maintenance. The method includes establishing a station sequence that includes a plurality of stations that a given part traverses. Each station includes at least one machine that performs at least one operation with respect to the given part. The method includes receiving measurement data relating to attributes of a plurality of parts. The measurement data is obtained by one or more sensors at each station of the plurality of stations. The measurement data corresponds to a current process period. The method includes generating, via a first machine learning model, latent representations, by encoding the measurement data into a latent space. The method includes generating, via the first machine learning model, at least machine states of the plurality of machines based on the latent representations. The method includes receiving machine observation data relating to the current process period. The machine observation data indicates conditions of the plurality of machines at the plurality of stations. The method includes generating aggregated data that is based on the measurement data and the machine observation data. The method includes generating, via a second machine learning model, a maintenance prediction based on the aggregated data, the maintenance prediction corresponding to a next process period.

These and other features, aspects, and advantages of the present invention are discussed in the following detailed description in accordance with the accompanying drawings throughout which like characters represent similar or like parts.

### BRIEF DESCRIPTION OF THE DRAWINGS

FIG. 1 is diagram of an example of a system for predictive maintenance according to an example embodiment of this disclosure.

FIG. 2 is diagram of a non-limiting example of an application of the system of FIG. 1 according to an example embodiment of this disclosure.

FIG. 3 is diagram of an example a predictive maintenance network of FIG. 1 according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling with the spirit and scope of this disclosure.

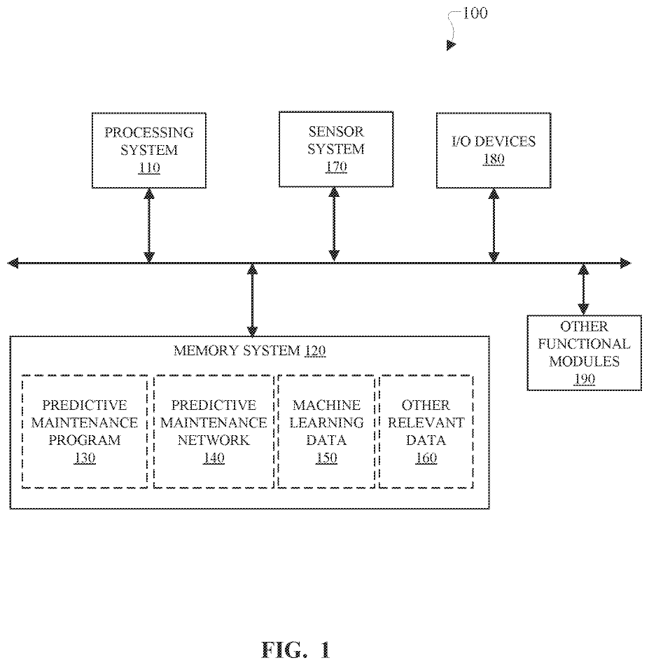

FIG. 1 is a diagram of a non-limiting example of a system 100, which is configured to generate maintenance predictions for a set of machines at a set of stations, where each station includes at least one machine configured to perform a manufacturing operation with respect to a given manufacturing part that goes through that station. These maintenance predictions allow for various actions to be taken to reduce maintenance overhead, as well as machine downtime. Furthermore, unlike techniques that rely solely on the physical observations of maintenance targets (e.g., the machines on which maintenance is to be performed), this system 100 leverages the measurement data of manufacturing parts being processed at these machines together with machine observation data of the conditions of these machines. In this regard, the system 100 recognizes that measurable characteristics of the manufacturing parts (or manufacturing products), which are produced by the machines, are directly connected to maintenance conditions of these machines. The system 100 is effective in integrating this manufacturing part measurement information with machine observation information to generate maintenance predictions regarding, for example, the likelihood that a machine requires maintenance in the next maintenance cycle or process period.

The system 100 includes at least a processing system 110 with at least one processing device. For example, the processing system 110 includes at least an electronic processor, a central processing unit (CPU), a graphics processing unit (GPU), a microprocessor, a field-programmable gate array (FPGA), an application-specific integrated circuit (ASIC), any suitable processing technology, or any number and combination thereof. The processing system 110 is operable to provide the functionality as described herein.

The system 100 includes a memory system 120, which is operatively connected to the processing system 110. In an example embodiment, the memory system 120 includes at least one non-transitory computer readable storage medium, which is configured to store and provide access to various data to enable at least the processing system 110 to perform the operations and functionality, as disclosed herein. In an example embodiment, the memory system 120 comprises a single memory device or a plurality of memory devices. The memory system 120 may include electrical, electronic, magnetic, optical, semiconductor, electromagnetic, or any suitable storage technology that is operable with the system 100. For instance, in an example embodiment, the memory system 120 includes random access memory (RAM), read only memory (ROM), flash memory, a disk drive, a memory card, an optical storage device, a magnetic storage device, a memory module, any suitable type of memory device, or any number and combination thereof. With respect to the processing system 110 and/or other components of the system 100, the memory system 120 is local, remote, or a combination thereof (e.g., partly local and partly remote). For example, the memory system 120 may include at least a cloud-based storage system (e.g. cloud-based database system), which is remote from the processing system 110 and/or other components of the system 100.

The memory system 120 includes at least a predictive maintenance program 130, a predictive maintenance network 140, machine learning data 150, and other relevant data 160, which are stored thereon. The predictive maintenance program 130 includes computer readable data with instructions, which, when executed by the processing system 110, is configured to train, deploy, and/or employ the predictive maintenance network 140 to generate maintenance predictions. The computer readable data includes instructions, code, routines, various related data, any software technology, or any number and combination thereof. In an example embodiment, the predictive maintenance network 140 includes at least a pretrained manufacturing model 300, an aggregator 310, and a predictive maintenance (PdM) model 320. Also, the machine learning data 150 includes various data relating to the predictive maintenance network 140. The machine learning data 150 includes various data associated with training, deploying, and/or employing the predictive maintenance network 140. For instance, the machine learning data 150 may include training data, various parameter data, various loss data, etc. Meanwhile, the other relevant data 160 provides various data (e.g., operating system, etc.), which enables the system 100 to perform the functions as discussed herein.

The system 100 is configured to include one or more sensor systems 170. The sensor system 170 includes one or more sensors. For example, the sensor system 170 may include an image sensor, a camera, a radar sensor, a light detection and ranging (LIDAR) sensor, a structured light sensor, a thermal sensor, a depth sensor, an ultrasonic sensor, an infrared sensor, a motion sensor, an audio sensor (e.g., microphone), a weight sensor, a pressure sensor, any applicable sensor, or any number and combination thereof. The sensor system 170 is operable to communicate with one or more other components (e.g., processing system 110 and memory system 120) of the system 100. For example, upon receiving sensor data from a sensor system 170, the sensor system 170 and/or the processing system 110 may generate sensor-fusion data. If needed, the processing system 110 may perform one or more data preparation operations to the sensor data and/or sensor-fusion data to provide input data (e.g., observed measurement data) of suitable form (e.g., numerical data) for the predictive maintenance network 140. The sensor system 170 is local, remote, or a combination thereof (e.g., partly local and partly remote). The sensor system 170 may include one or more sensors at one or more of the stations of a given station sequence that a given part traverses. Additionally or alternatively, there may be one or more sensor systems 170 at each station of the station sequence that a given part traverses. Upon receiving the sensor data, the processing system 110 is configured to process this sensor data in connection with the predictive maintenance program 130, the predictive maintenance network 140, the machine learning data 150, the other relevant data 160, or any number and combination thereof.

In addition, the system 100 may include at least one other system component. For example, as shown in FIG. 1, the memory system 120 is also configured to store other relevant data 160, which relates to operation of the system 100 in relation to one or more system components (e.g., sensor system 170, I/O devices 180, and other functional modules 190). In addition, the system 100 is configured to include one or more I/O devices 180 (e.g., display device, keyboard device, speaker device, etc.), which relate to the system 100. Also, the system 100 includes other functional modules 190, such as any appropriate hardware, software, or combination thereof that assist with or contribute to the functioning of the system 100. For example, the other functional modules 190 include communication technology (e.g. wired communication technology, wireless communication technology, or a combination thereof) that enables system components of the system 100 to communicate with each other as described herein.

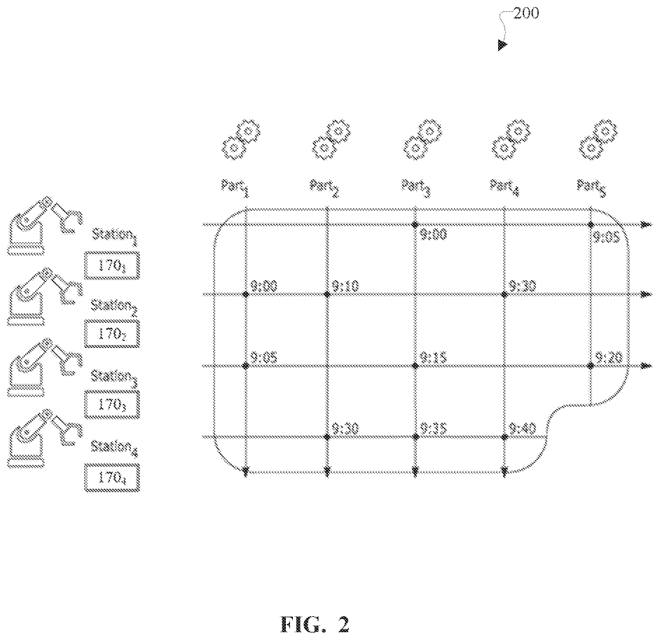

FIG. 2 is a non-limiting example of a graphical representation 200 of a time-ordered, directed graph model. As shown in FIG. 2, a part may go through several stations before the part is finished or a product is manufactured. After each machine/station completes one or more tasks, then measurements may be taken of the part to produce measurement data. This makes sure the part is sufficiently operational, sufficiently connected, sufficiently sized, etc. with respect to specified tolerances. Measurement data may include which type of station the measurement is taken, which type of part is being measured, and what is the measurement. The measurement data may be a binary value, a strength value, a time series value (e.g., a measurement of the response to pressure), floating precision number, number string, integer, Boolean, aggregation of statistics, or the like which represents a physical state, characteristic, or attribute of the part. This measurement data may be multimodal (e.g., may include multiple types of measurements, such as those listed above as an example). This multimodal measurement data may be input into the predictive maintenance network 140 described herein.

In the graphical representation 200, each black circle denotes multimodal measurement data or records associated with a particular part in relation to a particular station. Each black circle is also provided with a time stamp, indicating a time in which a particular part is measured by sensor system 170; at a particular station, where i represents an integer value greater than one. For instance, this graphical representation 200 captures the following measurement events: part1 is measured by one or more sensors of sensor system 1702 at station2 at 9:00, and measured by one or more sensors of sensor system 1703 at station3 at 9:05; part2 is measured by one or more sensors of sensor system 1702 at station2 at 9:10, and measured by one or more sensors of sensor system 1704 at station4 at 9:30; part3 is measured by one or more sensors of sensor system 1701 at station 1 at 9:00, measured by one or more sensors of sensor system 1703 at station3 at 9:15, and measured by one or more sensors of sensor system 1704 at station4 at 9:35; part4 is measured by one or more sensors of sensor system 1702 at station2 at 9:30 and measured by one or more sensors of sensor system 1704 at station4 at 9:40; part5 is measured by one or more sensors of sensor system 1701 at station1 at 9:05 and measured by one or more sensors of sensor system 1703 at station3 at 9:20. In this regard, part5 has passed through the station subsequence of station1 and station3 and further needs to pass through station4 to complete the established station sequence of station1, station3, and station4.

As discussed above, the graphical representation 200 illustrates non-limiting examples of measurement data collection at an assembly plant. Other non-limiting examples may include more or less than five parts and/or more or less than four stations. The arrows in the graph show the time progression for each part (going top to bottom), and for each station (going left to right). In addition, the graphical representation 200 includes an irregular shape around some measurement events as an illustrative and non-limiting sample of some measurement events that relate to some part sequence measurement data Z⁽ⁱ⁾, which is captured by the system 100. The system 100 is configured to use measurement data Z⁽ⁱ⁾ along with machine maintenance data (e.g., machine observations xᵢ discussed later) of this current process period to generate maintenance predictions. Advantageously, with these inputs, the system 100 is configured to provide a relatively accurate maintenance prediction of each station in a station sequence.

These maintenance predictions are advantageous as one part (e.g. part5) may be prevented from advancing to a station (e.g., station4) in the next process period if the system 100 generates a maintenance prediction that indicates that the machine at station4 will be faulty in that next process period. In this regard, for example, the process period (denoted by i) may refer to the shortest time interval that maintenance is schedulable for all stations. The process period is set based on a number of factors. As a non-limiting example, the process period may be set for a day (i=1 day), a week (e.g., i=7 days), any predetermined length of time, or any number and combination thereof. Furthermore, to generate one or more maintenance predictions, the system 100 includes the predictive maintenance network 140, as discussed below.

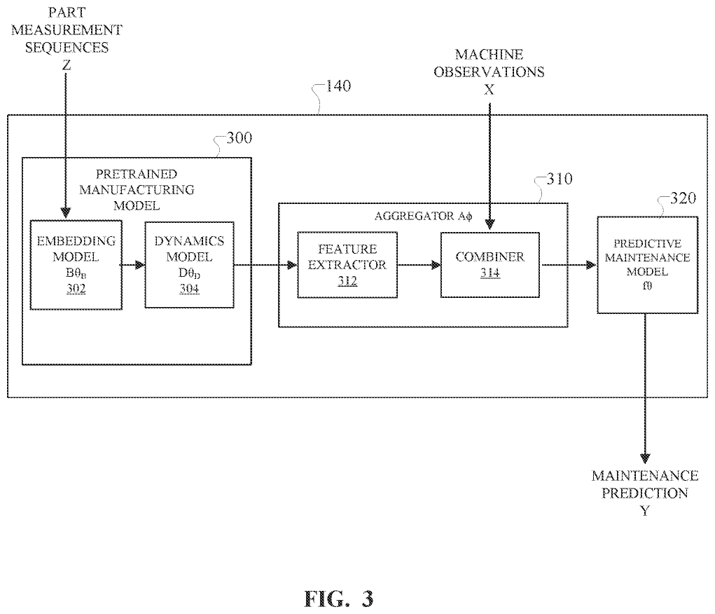

FIG. 3 is a diagram of the predictive maintenance network 140 according to an example embodiment. The predictive maintenance network 140 is configured to generate maintenance predictions, which include prediction data for each station. For example, the prediction data may include a time period before failure for the next process period or a remaining time period before failure for the next process period. The prediction data may include a classification label for the next process period, where the classification label is indicative of at least a faulty state or a non-faulty state (e.g., a normal state) of a particular machine at a prediction station. The prediction data includes a classification label for each machine/station of the station sequence. To generate maintenance predictions, which is based on the measurement data and the machine observation data, the predictive maintenance network 140 includes at least a pretrained multimodal manufacturing model 300, an aggregator 310, and a predictive maintenance (PdM) model 320.

The pretrained multimodal manufacturing model 300 includes at least two machine learning models. For example, in FIG. 3, the pretrained multimodal manufacturing model 300 includes at least an embedding model 302 and a dynamics model 304. In this regard, as shown in FIG. 3, the pretrained multimodal manufacturing model 300 may be represented as D_{θ}_{_{D}}(B_{θ}_{_{B}}(Z)), where D_{θ}_{_{D}} represents the dynamics model 304, B_{θ}_{_{B}} represents the embedding model 302, and Z represents the input data, as discussed later. More specifically, in this example, the embedding model 302 comprises at least one artificial/computer neural network (e.g., a graph neural network (GNN), a convolutional neural network (CNN), any suitable machine learning network, etc). Also, in this example, the dynamics model 304 comprises at least one artificial/computer neural network (e.g., GNN, CNN, any suitable machine learning network, etc.).

In order to reduce memory and computation consumption at training time, and to shorten inference time, the embodiments disclosed herein can use latent space to encode the subsequence of a part p's sequence x_{<i} into latent state h^{p}ᵢ=Encoder(x<i). This will further be described below with respect to batch processing. In an embodiment, an auto-regressive encoder is utilized, i.e., h^{p}ᵢ=h^{p}ᵢ₋₁+Encoder(xᵢ). Similarly, the system 100 is configured to encode the station subsequence up to the jth part into the latent state h^{s}ⱼ. Assuming part p is the ith part that gets measured by station si, then equation 1 is applicable.

$$P ( x ) = {∐}_{i = 1}^{k} p ( {x}_{i} \vert {h}_{i}^{p} , {h}_{{i}_{p}}^{{s}_{i}} ) \qquad [ 1 ]$$

The embedding model 302 comprises an embedding network or B_{θ}_{_{B}}, where B refers to a batch size. This embedding model 302 is configured to embed or encode a set of measurement data (e.g., measurement data of varying type such as floating precision number, string, integer, Boolean, time series measurements, aggregation of statistics, etc.) into a float array or vector that the dynamics model 304 can consume. The embedding model 302 may comprise any architecture that works effectively with the measurement data. For example, if the measurement data are all floating numbers or integers, then the embedding network may simply comprise a multi-layer perceptron. As another example, if the measurement data includes time series data, then the embedding network may comprise a 1-dimensional convolutional network to extract the features.

The dynamics model 304 comprises a dynamics network or D_{θ}_{_{D}}, where again D can be a part/station sub-sequence dataset encoded into a latent space. The dynamics model 304 may include any time-series model with latent representations (e.g., recurrent neural network, etc.). In this example, each part sequence in the dynamics model 304 contains information relating to at least the type of part, an identifier of the part, and the sequence of stations that this part goes through. The dynamics model 304 is configured to receive input data that includes (a) embeddings or latent representations received from the embedding model 302 and (b) a current latent representation of the part state and the machine/station state, i.e.,

$${h}_{i}^{p} , {h}_{{i}_{p}}^{{s}_{i}} .$$

Upon obtaining this input data, the dynamics model 304 is configured to generate the updated part state and the updated machine/station state

$$( i . e . , {h}_{i + 1}^{p} , {h}_{{i}_{p + 1}}^{{s}_{i}} )$$

as output data.

In FIG. 2 and FIG. 3, for example, the set of machines correspond to the set of stations, which may be represented as S={s₁, s₂, . . . , sₖ}, where k represents the total number of stations of that set. Also, this set of machines produce a number of parts (where the number is denoted by q) with corresponding part measurement sequences Z⁽ⁱ⁾={z₁, z₂, . . . , z_{q}}⁽ⁱ⁾ in the ith process period, where i represents an integer value. Referring to FIG. 2, as a non-limiting example, for instance, a part measurement sequence for part3 is z3⁽ⁱ⁾ that includes {[part3 measured at the machine at station s₁: voltage 0.7V, result OK], [part3 measured at the machine at station s₃: solder 2 width 0.3 nm, solder 4 width 0.1 nm], [part3 measured at the machine at station s₄: spray location x 0.10 cm, spray location y 0.00 cm, spray location z 0.02 cm]}. The set of measurement sequences Z for all parts are passed into the embedding network B_{θ}_{_{B}} and the dynamic module D_{θ}_{_{D}} of the pretrained manufacturing model 300 to obtain the hᵢ={h^{s}^{₁}, h^{s}^{₂}, . . . , h^{s}^{ₖ}}, such that D_{θ}_{_{D}}(B_{θ}_{_{B}}(Z⁽ⁱ⁾))={h^{s}^{₁}, h^{s}^{₂}, . . . , h^{s}^{ₖ}} for the machines corresponding to stations {s₁, s₂, . . . , sₖ} at the end of this process period. As a non-limiting example, for instance, a latent representation of a machine state (i.e., h^{s}^{₁}) of a machine at station 1 may be represented as a 1 by 256 vector of float values and viewed as 1-dimensional sequence data with length of 256.

The aggregator 310 is configured to receive the latent representations of the machine states from the dynamics model 304. In addition, the aggregator 310 is configured to receive machine observation data, which relates to conditions of the machines during the current process period (or the same process period as the measurement data Z). The aggregator 310 is configured to generate aggregated data by combining the machine state data and the machine observation data. The aggregator 310 is configured to directly aggregate hᵢ with xᵢ such that A_{ϕ}(xᵢ, hᵢ) is input to f_{θ}. More specifically, A_{ϕ}(.) represents an aggregation function, which may include, but is not limited to, feature extraction of hᵢ and/or xᵢ (so hᵢ and xᵢ have the same dimension in at least all but one axis) and combining hᵢ and xᵢ by concatenation or weighted averaging. The aggregation function A_{ϕ} is parameterized by ϕ (if applicable). In this regard, ϕ denotes parameters for aggregation, including both feature extraction and weights. The aggregation function A_{ϕ} includes, for instance, (i) applying a multi-head self-attention layer to hᵢ to generate a feature map and (ii) concatenating the self-attention output (e.g., the feature map) with xᵢ.

In FIG. 3, for example, the aggregator 310 includes at least a feature extractor 312 and a combiner 314. The feature extractor 312 is configured to generate a feature map of the latent representations of the machine/station states. The feature extractor 312 may comprise any suitable module to extract features of the latent representations. As an example, for instance, the feature extractor 312 comprises a self-attention module. The self-attention module comprises a deep neural network that embeds (by multiplying with trainable matrices) input sequences into key, query, and value vectors. The self-attention module also computes attention scores of a corresponding query with all keys, and then takes softmax of the attention scores as weights to weighted-average the values as output. When using the self-attention module as the feature extractor 312, the self-attention module is configured to have a dimension for each value that is the same as a dimension of xᵢ so that the output data (e.g., feature map) of self-attention is easily combined with xᵢ. As another example, the feature extractor 312 comprises at least one fully connected layer. More specifically, the fully-connected layer is configured to have an input dimension that is the same dimension (e.g., 256 in earlier example that resulted in a 1 by 256 vector of float values) as the latent representation (e.g. h^{s}^{₃}) of a machine/station state at a particular station (e.g., station3 for h^{s}^{₃}), and an output dimension (e.g., output dimension of 3 when K=3) that is the same dimension as xᵢ. Furthermore, as shown in FIG. 3, upon generating the feature map, the feature extractor 312 provides the feature map to the combiner 314.

The combiner 314 is configured to combine the feature map and the machine observation data. The combiner 314 is configured to receive the feature map from the feature extractor 312. In addition, the combiner 314 is configured to receive the machine observations xᵢ. In this regard, for instance, as a non-limiting example, a machine observation xᵢ of an ith process period is represented as a n-machine by K-matrix, where each row of this matrix represents K-dimensional information relating to the last failure of this machine. For instance, this K-dimsional information may include a time since most recent (or last) failure, type of most recent (or last) failure, and error code of the most recent (or last) failure such that K=3 in this example. For example, upon receiving the feature map and the machine observations, the combiner 314 is configured to generate aggregated data by concatenating the feature map with the machine observation data. As another example, upon receiving the feature map and the machine observations, the combiner 314 is configured to generate aggregated data by combining the feature map with the machine observation data via weighted averaging. Furthermore, upon generating the aggregated data, the combiner 314 provides the aggregated data to the PdM model 320.

The PdM model 320 is configured to generate a maintenance prediction based on the aggregated data. The PdM model 320, f_{θ}, is parameterized by θ. For the PdM model 320, the dataset includes machine observation xᵢ and maintenance information yᵢ of process period i, manufacturing part measurement sequence dataset Z={Z⁽ⁱ⁾}ᵢ₌₁ⁿ, where Z(i) contains measurement sequences of parts being processed in the process period (denoted as i), number of epoch (denoted as n), and loss function (denoted as L) used for training f_{θ}.

As one example, the PdM model 320 comprises a classification model. Based on the aggregated data (denoted as j), the PdM model 320 is configured to generate yᵢ indicating whether or not a machine will function normally (yᵢ[j]=0, . . . ) or fail with a certain failure type (yᵢ[j]=1, . . . ) for the next process period. Given the aggregated data as input, when the PdM model 320 includes the classification model, then f_{θ}(x) may generate a probability of machine failure in the next process period. The PdM model 320 may be configured to generate a predetermined number of classes to classify a faulty operation and the type of fault or a non-faulty operation.

As another example, the PdM model 320 comprises a regression model. In this regard, for instance, the regression model is configured to generate yᵢ, which indicates time until next failure for each machine. Given the aggregated data as input, when the PdM model 320 includes the regression model, then f_{θ}(x) returns each machine's remaining useful time before a next fault.

During training, for each machine-observation and label pair (xᵢ, yᵢ) and part measurement sequences Z⁽ⁱ⁾, the predictive maintenance network 140 is configured to generate machine states sᵢ via D_{θ}_{_{D}}(B_{θ}_{_{B}}(Z⁽ⁱ⁾)) such that D_{θ}_{_{D}}(B_{θ}_{_{B}}(Z⁽ⁱ⁾))=sᵢ. The predictive maintenance network 140 aggregates hᵢ with xᵢ using the aggregation function A_{ϕ} of the aggregator 310. More specifically, as an example, the aggregator 310 applies multi-head self-attention with parameters ϕ to obtain a feature map of the latent representations of the machine states. Also, as an example, the aggregator 310 is configured to concatenate the feature map and the machine observations xᵢ. The predictive maintenance network 140 uses an optimizer and learning rate schedular to update θ via equation 2. In addition, the predictive maintenance network 140 uses an optimizer and learning rate schedular to update ϕ via equation 3. The predictive maintenance network 140 iterates through all items in S and Z. In addition, the predictive maintenance network 140 is configured to repeat an iteration for a predetermined number of times.

$$\partial L ( {f}_{θ} ( {A}_{ϕ ( {x}_{i} , {s}_{machine} )} ) , {y}_{i} ) / \partial θ \qquad [ 2 ]$$

$$\partial L ( {f}_{θ} ( {A}_{ϕ ( {x}_{i} , {s}_{machine} )} ) , {y}_{i} ) / \partial ϕ \qquad [ 3 ]$$

During inference, the predictive maintenance network 140 is configured to obtain, for the current process period (i.e., the ith-process period), at least (a) machine observations x indicative of conditions of the machines at the stations, and (b) part measurement sequences Z of parts being processed by the machines at the stations. The predictive maintenance network 140 is configured to generate machine states via D_{θ}_{_{D}}(B_{θ}_{_{B}}(Z) using the part measurement sequences Z. The predictive maintenance network 140 is configured to generate maintenance predictions via f_{θ}(A_{ϕ(j)}) based on the aggregated data j, which includes the machine states h and the machine observations x. The maintenance predictions may include a predicted downtime of a machine/station for the next process period, predicted probability of failure of a machine/station for the next process period (i.e., i+1), a predicted time until a failure of the machine/station, or any previously discussed predication data.

As described in this disclosure, the system 100 provides several advantages and benefits. For example, the system 100 is configured to generate maintenance predictions that integrates part measurement sequences with machine observations, thereby providing greater insight and accuracy in maintenance assessments of each machine for the next process period. These maintenance predictions may be used to determine if there are any potential/future issues that need to be addressed with respect to one or more of the industrial machines. In some cases, these maintenance predictions may be displayed on display devices and/or trigger electronic alerts on various technological devices so that users are notified of possible failures and can address one or more industrial machines before the next process period. These maintenance predictions enable various actions (e.g., preventative actions, maintenance actions, etc.) to be taken in advance to prevent machine downtime/failure, thereby benefiting manufacturing processes.

That is, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. Additionally or alternatively, components and functionality may be separated or combined differently than in the manner of the various described embodiments, and may be described using different terminology. These and other variations, modifications, additions, and improvements may fall within the scope of the disclosure as defined in the claims that follow.

What is claimed is:

1. A computer-implemented method for predictive maintenance, the method comprising:
establishing a station sequence that includes a plurality of machines at a plurality of stations that a given part traverses, each station including at least one machine that performs at least one operation with respect to the given part;
receiving measurement data relating to attributes of a plurality of parts, the measurement data being obtained by one or more sensors at each station of the plurality of stations, the measurement data corresponding to a current process period;
generating, via a first machine learning model, latent representations, by encoding the measurement data into a latent space;
generating, via the first machine learning model, at least machine states of the plurality of machines based on the latent representations;
receiving machine observation data relating to the current process period, the machine observation data indicating conditions of the plurality of machines at the plurality of stations;
generating aggregated data that is based on the measurement data and the machine observation data; and
generating, via a second machine learning model, a maintenance prediction based on the aggregated data, the maintenance prediction corresponding to a next process period.

2. The computer-implemented method of claim 1, further comprising:
generating a feature map by performing feature extraction on the machine states,
wherein the aggregated data is generated by combining the feature map and the machine observation data.

3. The computer-implemented method of claim 2, wherein the feature map and the machine observation data are combined by concatenation or weighted averaging.

4. The computer-implemented method of claim 2, wherein the feature extraction is performed by passing the machine states through a self-attention layer or a fully connected layer to generate the feature map.

5. The computer-implemented method of claim 1, wherein:
the second machine learning model includes a regression model;
the maintenance prediction includes prediction data for each station; and
the prediction data includes a time period before machine failure for the next process period.

6. The computer-implemented method of claim 1, wherein:
the second machine learning model includes a classification model;
the maintenance prediction includes prediction data for each station; and
the prediction data includes a classification state for the next process period, the classification state being indicative of a faulty state or a non-faulty state.

7. The computer-implemented method of claim 1, wherein:
the measurement data is based on multimodal sensor data; and
the first machine learning model includes (i) an embedding model to encode the measurement data into latent representations and (ii) a dynamics model to update the machine states based on the latent representations.

8. A system comprising:
a processor; and
a memory in data communication with the processor, the memory having computer readable data including instructions stored thereon that, when executed by the processor, cause the processor to perform a method for predictive maintenance, the method including:
establishing a station sequence that includes a plurality of machines at a plurality of stations that a given part traverses, each station including at least one machine that performs at least one operation with respect to the given part;
receiving measurement data relating to attributes of a plurality of parts, the measurement data being obtained by one or more sensors at each station of the plurality of stations, the measurement data corresponding to a current process period;
generating, via a first machine learning model, latent representations, by encoding the measurement data into a latent space;
generating, via the first machine learning model, at least machine states of the plurality of machines based on the latent representations;
receiving machine observation data relating to the current process period, the machine observation data indicating conditions of the plurality of machines at the plurality of stations;
generating aggregated data that is based on the measurement data and the machine observation data; and
generating, via a second machine learning model, a maintenance prediction based on the aggregated data, the maintenance prediction corresponding to a next process period.

9. The system of claim 8, wherein the method further comprises:
generating a feature map by performing feature extraction on the machine states,
wherein the aggregated data is generated by combining the feature map and the machine observation data.

10. The system of claim 9, wherein the feature map and the machine observation data are combined by concatenation or weighted averaging.

11. The system of claim 9, wherein the feature extraction is performed by passing the machine states through a self-attention layer or a fully connected layer to generate the feature map.

12. The system of claim 8, wherein:
the second machine learning model includes a regression model;
the maintenance prediction includes prediction data for each station; and
the prediction data includes a time period before machine failure for the next process period.

13. The system of claim 8, wherein:
the second machine learning model includes a classification model;
the maintenance prediction includes prediction data for each station; and
the prediction data includes a classification state for the next process period, the classification state being indicative of a faulty state or a non-faulty state.

14. The system of claim 8, wherein:
the measurement data is based on multimodal sensor data; and
the first machine learning model includes (i) an embedding model to encode the measurement data into latent representations and (ii) a dynamics model to update the machine states based on the latent representations.

15. A non-transitory computer readable medium having computer readable data including instructions stored thereon that, when executed by a processor, cause the processor to perform a method for predictive maintenance, the method including:
establishing a station sequence that includes a plurality of machines at a plurality of stations that a given part traverses, each station including at least one machine that performs at least one operation with respect to the given part;
receiving measurement data relating to attributes of a plurality of parts, the measurement data being obtained by one or more sensors at each station of the plurality of stations, the measurement data corresponding to a current process period;
generating, via a first machine learning model, latent representations, by encoding the measurement data into a latent space;
generating, via the first machine learning model, at least machine states of the plurality of machines based on the latent representations;
receiving machine observation data relating to the current process period, the machine observation data indicating conditions of the plurality of machines at the plurality of stations;
generating aggregated data that is based on the measurement data and the machine observation data; and
generating, via a second machine learning model, a maintenance prediction based on the aggregated data, the maintenance prediction corresponding to a next process period.

16. The non-transitory computer readable medium of claim 15, wherein the method further comprises:
generating a feature map by performing feature extraction on the machine states,
wherein the aggregated data is generated by combining the feature map and the machine observation data.

17. The non-transitory computer readable medium of claim 16, wherein the feature map and the machine observation data are combined by concatenation or weighted averaging.

18. The non-transitory computer readable medium of claim 16, wherein the feature extraction is performed by passing the machine states through a self-attention layer or a fully connected layer to generate the feature map.

19. The non-transitory computer readable medium of claim 15, wherein:
the second machine learning model includes a regression model;
the maintenance prediction includes prediction data for each station; and
the prediction data includes a time period before machine failure for the next process period.

20. The non-transitory computer readable medium of claim 15, wherein:
the second machine learning model includes a classification model;
the maintenance prediction includes prediction data for each station; and
the prediction data includes a classification state for the next process period, the classification state being indicative of a faulty state or a non-faulty state.
